(19) United States
(12) Patent Application Publication
(10) Pub. No.: US 2012/0151087 A1
(43) Pub. Date: Jun. 14, 2012

(54) SYSTEM AND METHOD FOR PROVIDING A NETWORK PROXY DATA TUNNEL

(75) Inventor: Syed Aamer Azam, San Jose, CA (US)

(73) Assignee: NUVEL, INC., Campbell, CA (US)

(21) Appl. No.: 13/326,189

(22) Filed: Dec. 14, 2011

Related U.S. Application Data
(60) Provisional application No. 61/423,039, filed on Dec. 14, 2010.

(51) Int. Cl. G06F 15/16

(52) U.S. Cl. 709/233

(57) ABSTRACT

A system and method for providing a network proxy data tunnel (NPDT), for use in large corporate network environments. A data tunnel is configured to multiplex/de-multiplex IP network transmission, and optimize the network protocol (e.g. TCP, UDP). A data reduction protocol is also used to optimize the network transmission. By multiplexing from the sender, and de-multiplexing on the receiver side, network bandwidth can be enhanced and optimized. The technique also greatly reduces network latency across networks and increases data throughput rate. In accordance with an embodiment, the system can use both network-based and content-based techniques to increase the data throughput rate. The data tunnel can encompass nearly all the latency in the data path, and allow minimal latency between the source of the data and the beginning of the data tunnel; or between the end of the tunnel and the data target.

### CLAIM OF PRIORITY

This application claims the benefit of priority to U.S. Provisional Patent Application titled “SYSTEM AND METHOD FOR PROVIDING A NETWORK PROXY DATA TUNNEL”, Application No. 61/423,039, filed Dec. 14, 2010, which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention is generally related to computer networks, and is particularly related to a system and method for providing a network proxy data tunnel.

### BACKGROUND

Generally, a proxy server is a computer system that acts as a filtering system, such as might be used to provide a secure Internet connection. For example, in a large corporate network environment, proxy servers can be used to filter TCP data packets (e.g. on port 80 or HTTP), to allow corporate Internet usage to be monitored. The basis of the proxy model is to capture all IP data packets that are being sent out via the network, and optimize transmission to its full potential, while maintaining reliability. However, in a lot of instances, the network bandwidth is not utilized to its full capacity, due to restrictions such as network latency and network congestion. As such, typically, users cannot use the full extent of the bandwidth available to them. This is the general area that embodiments of the invention are intended to address.

### SUMMARY

Described herein is a system and method for providing a network proxy data tunnel (NPDT), for use in large corporate network environments. In accordance with an embodiment, the system acts as a proxy server on or next to a sender/receiver, to create a data tunnel. The data tunnel is configured to multiplex/de-multiplex IP network transmission, and optimize the network protocol (e.g. TCP, UDP). A data reduction protocol is also used to optimize the network transmission. By multiplexing from the sender, and de-multiplexing on the receiver side, network bandwidth can be enhanced and optimized. The technique also greatly reduces network latency across networks and increases data throughput rate. In accordance with an embodiment, the system can use both network-based and content-based techniques to increase the data throughput rate. The data tunnel can encompass nearly all the latency in the data path, and allow minimal latency between the source of the data and the beginning of the data tunnel; or between the end of the tunnel and the data target.

### BRIEF DESCRIPTION OF THE FIGURES

FIG. 1 illustrates the use of proxies with a network proxy data tunnel installed at a computer server, in accordance with an embodiment.

FIG. 2 illustrates a configuration of the network proxy data tunnel settings, for a Filezilla FTP client, in accordance with an embodiment.

FIG. 3 illustrates the configuration of the network proxy data tunnel settings, for a Firefox Web Browser client, in accordance with an embodiment.

FIG. 4 illustrates an example use of the network proxy data tunnel, as provided as an OS kernel driver model, in accordance with an embodiment.

FIG. 5 illustrates another example use of the network proxy data tunnel, with an additional server, in accordance with an embodiment.

FIG. 6 illustrates another example use of the network proxy data tunnel, in a complex network architecture, in accordance with an embodiment.

FIG. 7 illustrates another example use of the network proxy data tunnel, in a cloud environment, in accordance with an embodiment.

FIG. 8 illustrates a method of using proxies with a network proxy data tunnel, in accordance with an embodiment.

### DETAILED DESCRIPTION

As described above, generally, a proxy server is a computer system that acts as a filtering system, such as might be used to provide a secure Internet connection. For example, in a large corporate network environment, proxy servers can be used to filter TCP data packets (e.g. on port 80 or HTTP), to allow corporate Internet usage to be monitored. The basis of the proxy model is to capture all IP data packets that are being sent out via the network, and optimize transmission to its full potential, while maintaining reliability. However, in a lot of instances, the network bandwidth is not utilized to its full capacity, due to restrictions such as network latency and network congestion. As such, typically, users cannot use the full extent of the bandwidth available to them.

In accordance with an embodiment, described herein is a system and method for providing a network proxy data tunnel (NPDT), for use in large corporate network environments. In accordance with an embodiment, the system acts as a proxy server on or next to a sender/receiver, to create a data tunnel. The data tunnel is configured to multiplex/de-multiplex IP network transmission, and optimize the network protocol (e.g. Transmission Control Protocol (TCP), User Datagram Protocol (UDP)). A data reduction protocol is also used to optimize the network transmission. By multiplexing from the sender, and de-multiplexing on the receiver side, network bandwidth can be enhanced and optimized. The technique also greatly reduces network latency across networks and increases data throughput rate. In accordance with an embodiment, the system can use both network-based and content-based techniques to increase the data throughput rate. The data tunnel can encompass nearly all the latency in the data path, and allow minimal latency between the source of the data and the beginning of the data tunnel; or between the end of the tunnel and the data target.

### Network-Based Data Transfer Rate Increase

When a protocol such as TCP is used to transfer data, the data transfer depends on several parameters, such as the TCP window size and the round trip latency. These parameters can be used to compute the maximum data throughput between any two points. The throughput is independent of the actual bandwidth.

For example, consider an environment which uses a 2.2 Gbps fiber network link from San Francisco to London, with a round trip latency of 200 milliseconds. If we attempt to transfer a large data file from a server in San Francisco to a server in London, we can estimate the best effective data throughput that can be achieved. To estimate this, we first convert the TCP window size from bytes to bits. In this instance we are using the standard 64 KB TCP window size of a Windows machine, which can be expressed as 65536 Bytes or 65536*8=524288 bits. If the latency is 200 milliseconds, then the maximum data throughput is

$$\frac{524288 bits}{0.200 sec} = 2621440 bits \text{/} sec = \frac{2621440}{( {1024}^{2} ) Mbps} = 2.5 Mbps$$

This means that, even though the fiber network link may support a 2.2 Gbps bandwidth, we would be unable to utilize more than 2.5 Mbps of that bandwidth. In this example the effective bandwidth is reduced by a factor of approximately 1000.

In accordance with an embodiment, techniques can be used to modify the data transfer rate so as to effectively fill the large data pipe. In accordance with an embodiment, since the latency is fixed, the TCP window size can be reduced.

The TCP window size is often controlled by the operating system. In order to reduce the window size another protocol, such as UDP, can be used, which unlike TCP does not require acknowledgement of packets received. In accordance with an embodiment, UDP can be used to build a data protocol that resembles TCP in every other aspect, but utilizes a different window size, wherein the window size can be made adjustable.

For example, returning to the previous example, the window size of 64 KB was originally dictated by the Windows operating system. If instead, UDP is used, this allows the window size to be adjusted to a desired number. If the window size is adjusted to, say 5 MB, the new throughput can now be calculated as 5 MB (bytes) or 5*1024*1024*8=41943040 bits. If the latency is again 200 milliseconds, the maximum data throughput is now

$$\begin{matrix}\frac{41943040 bits}{0.200 sec} = 209715200 bits \text{/} sec \\ = \frac{209715200}{( {1024}^{2} ) Mbps} = 200 Mbps\end{matrix}$$

The new data throughput is now 200 Mbps, i.e. it has been increased by a factor of 200/2.5=80, by adjusting the size of the data window. This ratio can be increased further by further tweaking the data window size.

Another way to increase data throughput is to use multiple TCP connections. TCP congestion can limit the number of multiple data connections that can be used, i.e. the maximum number of TCP connections is limited by the data loss that is incurred as a result of data congestion. For example, 8 to 10 multiple TCP connections will typically speed up the data transfer considerably.

### Content-Based Data Transfer Rate Increase

Lossless data compression allows an original data to be exactly reconstructed from a compressed data. Typically, a lossless compression algorithm generates a statistical model for the data, and then uses this model to map an input data to bit sequences in such a way that more frequently encountered data will require smaller output than less frequent data sequences.

In accordance with an embodiment, the system provides a compression scheme that uses a combination of two or more schemes to compress data for transmission of the data tunnel. The data is first analyzed against well-known statistical patterns found in the types of data sequences that are propagated across the Internet. These can include, e.g. HTML, HTTP, SMTP, POP3 and IMAP headers, and Microsoft Exchange protocol headers. The data is analyzed to see if any of these patterns exist. If a match is found, then the resulting compression will often be superior to a generic technique (such as gzip), since more complex statistical patterns will tend to compress better. If the data analysis does a not detect a statistical pattern that matches the patterns found in the typical data sequences described above, then a generic compression algorithm such as LZ77, LZW, or a Context Tree Weighting method can be used.

### Network Proxy Data Tunnel Usage

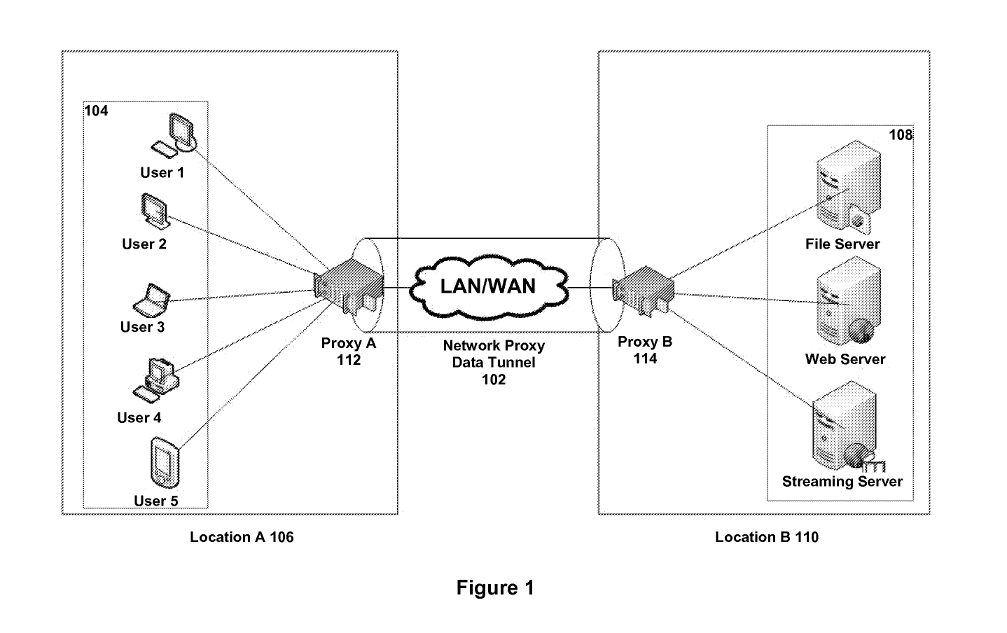

FIG. 1 illustrates the use of proxies with a network proxy data tunnel 102 installed at a computer server, in accordance with an embodiment. As shown in FIG. 1, users 104 (shown here as Users 1, 2, 3, 4 and 5 respectively) at a location A 106 may need to access network resources 108 at a location B 110 (e.g. Web, file, or streaming resources, etc.). Using their software client (e.g. Web Browser, FTP Client, Media Player, etc), the users can specify the relevant proxy settings on their specific software client. By doing this, all the network data packets will then go through proxy A 112. Proxy A checks the destination IP address, to see if it is within its routing database. After finding the routing access, proxy A will then send the data packet across the network proxy data tunnel to proxy B 114, which reroutes directly to the corresponding server.

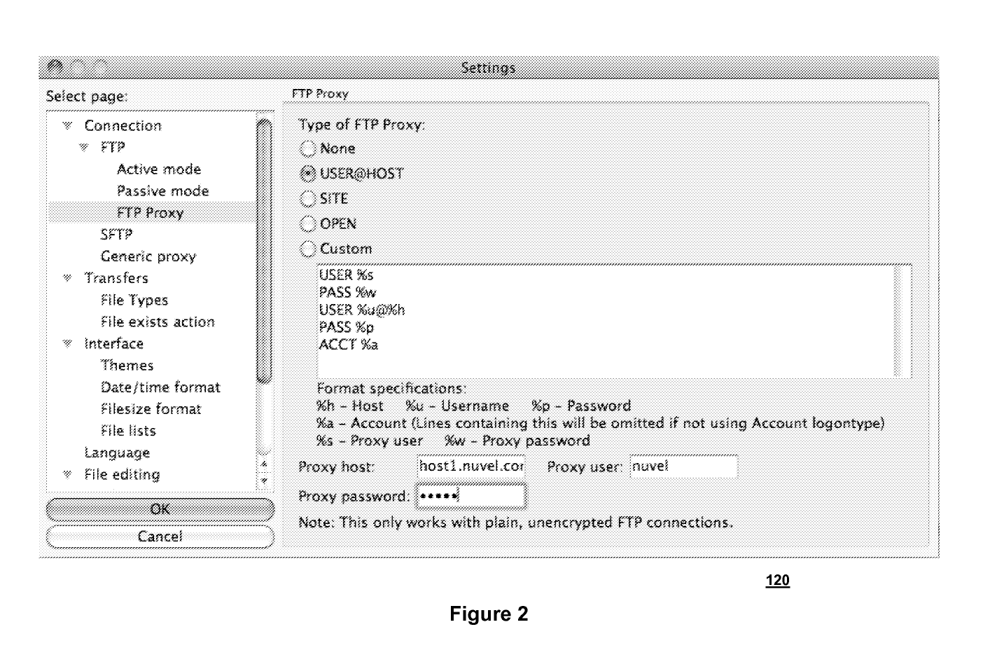

FIG. 2 illustrates a configuration 120 of the network proxy data tunnel settings, for a Filezilla FTP client, in accordance with an embodiment. As shown in FIG. 2, a user can modify their settings, such as type of proxy, proxy host name, user and password, to implement the network data tunnel with that proxy.

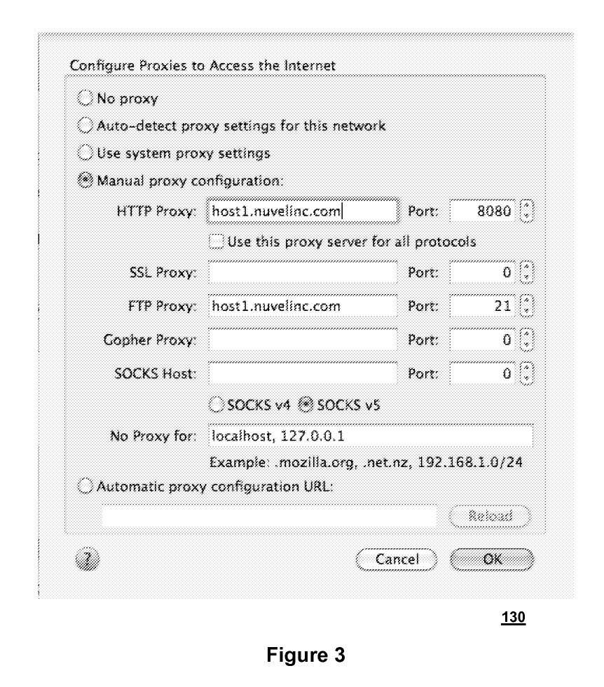

FIG. 3 illustrates the configuration 130 of the network proxy data tunnel settings, for a Firefox Web Browser client, in accordance with an embodiment. As shown in FIG. 3, a user can similarly modify their settings, such as type of proxy, proxy host name, user and password, to implement the network data tunnel with that proxy. Other interfaces for other types of clients can be similarly provided.

### OS Kernel Driver Model

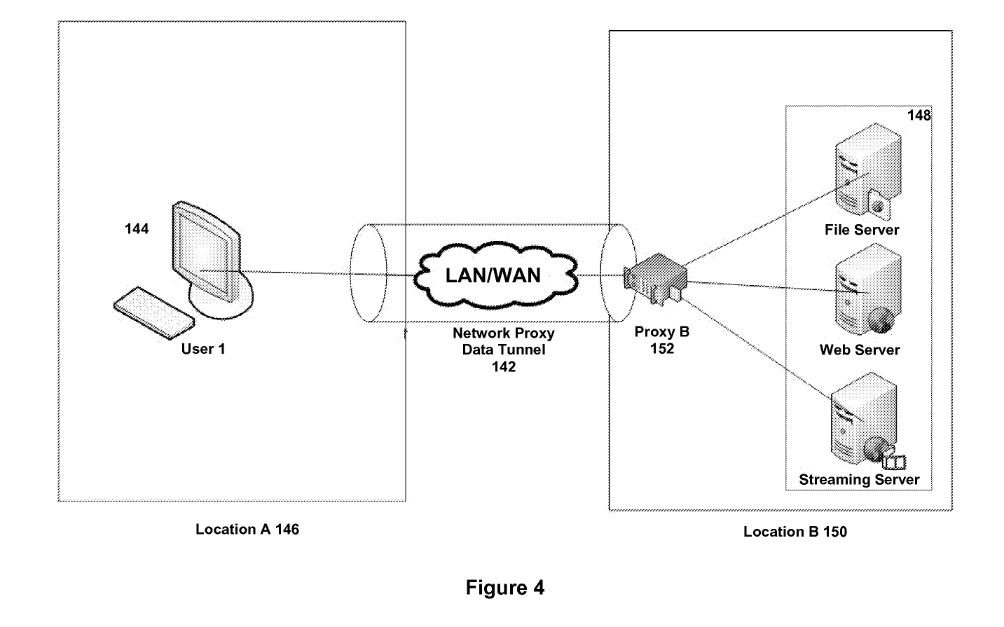

FIG. 4 illustrates an example use of the network proxy data tunnel, as provided as an OS kernel driver model, in accordance with an embodiment. As shown in FIG. 4, in accordance with an embodiment, the network proxy data tunnel software 142 can be installed locally on a User 1 computer or machine 44. In accordance with this embodiment, the software provides a virtual device driver, which captures all IP data packets communicated into and out of that machine. For example, if User 1 at a location A 146 requests network resources 148 (e.g. Web, file, or streaming resources, etc.) at a location B 150, the machine sends the packet with network proxy data tunnel technology across the LAN/WAN network to proxy B 152, using the same techniques of proxy filtering as described above. Proxy B then sends the data packet to the corresponding server.

Scenarios with Proxy Type Software Application

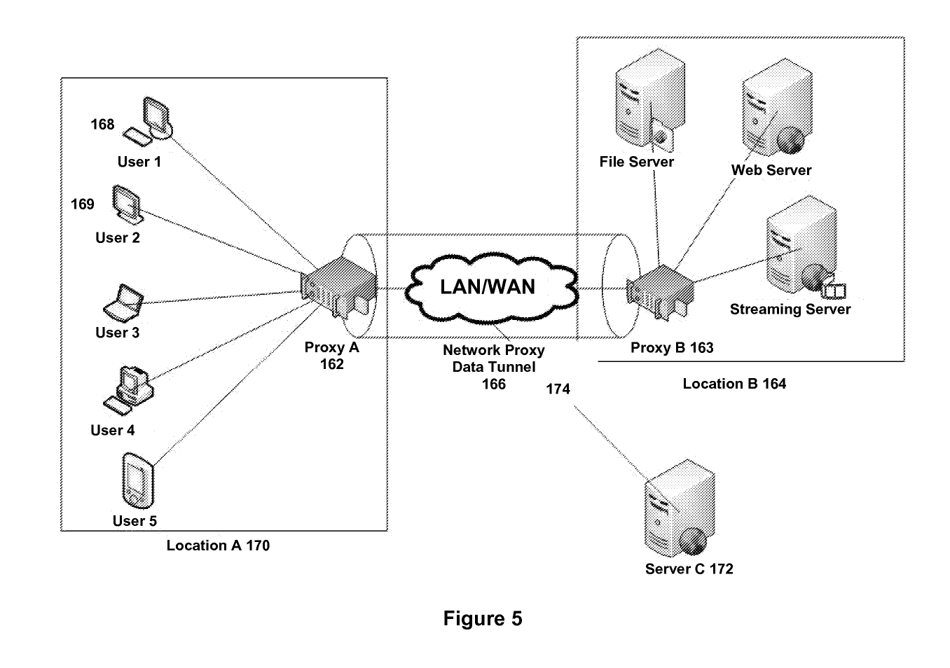

FIG. 5 illustrates another example use of the network proxy data tunnel, with an additional server, in accordance with an embodiment. As shown in FIG. 5, a corporation with multiple locations may have a proxy A 162 and proxy B 163, with a network proxy data tunnel software 166 installed on a computer server. When a User 1 (168) at a location A 170 requests network resources (e.g. Web, file, or streaming resources, etc) at a location B 164, the request data packets go through proxy A. Proxy A uses the network proxy data tunnel software to send the data packet to proxy B. After examining its routing table, proxy B sends the data packet to the corresponding server. The server then sends the requested data packet back to proxy B, which forwards it to proxy A. Proxy A thens send the data packet to User 1. When a User 2 (169) at location A instead requests network resources on Server C 172, the request data packet is sent to proxy A. Proxy A then examines its routing table, and sees that there is not a corresponding proxy B to send the data packet to. It will then bypass the network proxy data tunnel, and send the data packet directly 174 to Server C.

### Complex Network Architecture

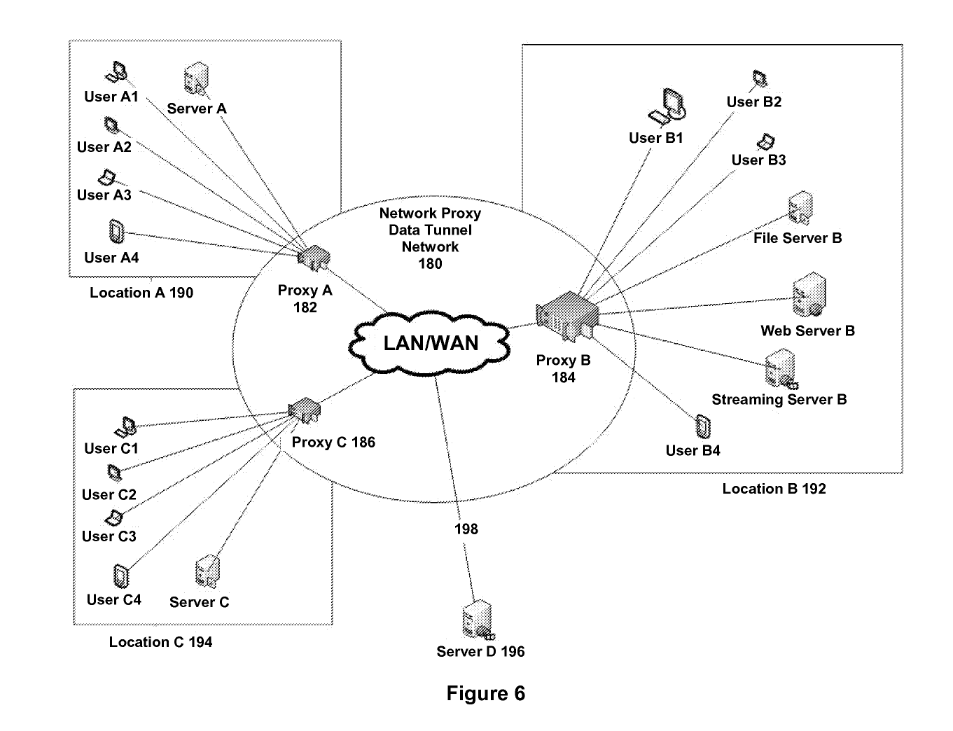

FIG. 6 illustrates another example use of the network proxy data tunnel, in a complex network architecture 180, in accordance with an embodiment. As shown in FIG. 6, in a complex network architecture where there are three or more locations, proxy A 182, proxy B 184, and proxy C 186 each have network proxy data tunnel software installed on a computer server. Using the same techniques of proxy filtering as described above, the system can provide a NPDT network. In this architecture, users from location A 190 can access any resources from location B 192 or location C 194 using the network proxy data tunnel as described above. Similarly, User B1 can access Server A or Server C using the NPDT network. If users want to access Server D 196, then the proxy residing in that location will bypass the network proxy data tunnel, and send the data packet directly 198 to Server D.

### Cloud Computing Environment

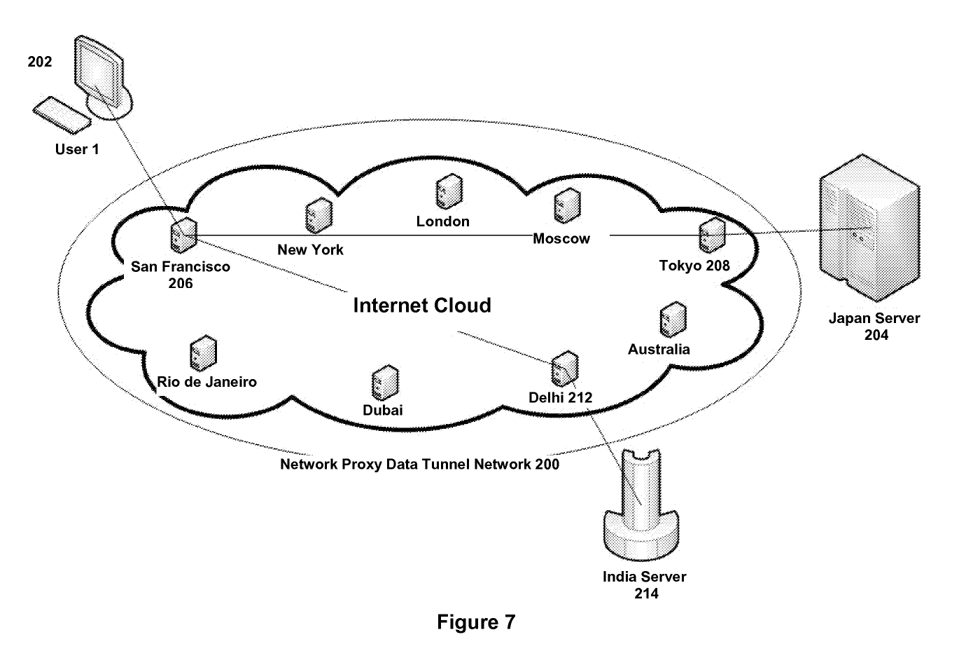

FIG. 7 illustrates another example use of the network proxy data tunnel, in a cloud environment 200, in accordance with an embodiment. As shown in the example of FIG. 7, User 1 (202) is based in San Francisco, and needs resources from a Japan Server 204. Using the network proxy data tunnel techniques described above, the request will be sent to the San Francisco NPDT Server 206, and will then be re-routed to the Tokyo NPDT Server 208, that will send the data request to the Japan Server. The Japan server will then send the response to the Tokyo NPDT Server, which will then send the data packet to the San Francisco NPDT Server, which will send the response to User 1. User 1 can also request resources at the India Server 214. The San Francisco NPDT server will able to find the quickest and most efficient way to send directly to the NPDT Delhi Server 212. This allows for installation of multiple NPDT Servers in different location of the world, which can create a NPDT Area Network to accelerate the packets across the network. Network latency is greatly reduced within the NPDT network boundaries.

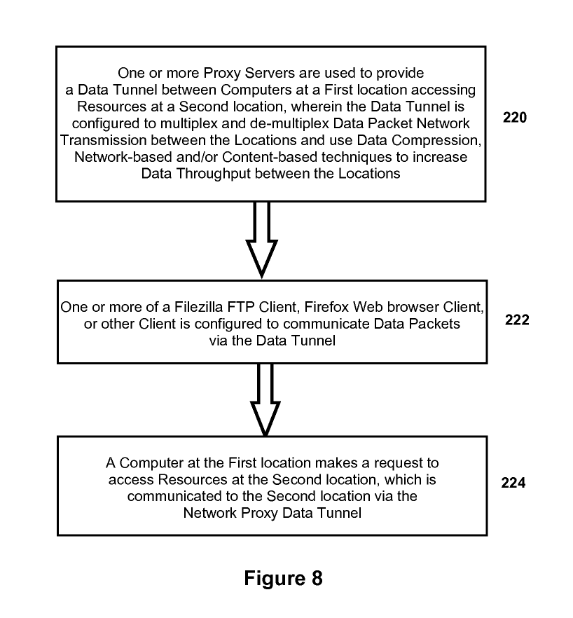

FIG. 8 illustrates a method of using proxies with a network proxy data tunnel, in accordance with an embodiment. As shown in FIG. 8, at step 220, one or more proxy servers are used to provide a data tunnel between computers at a first location accessing resources at a second location, wherein the data tunnel is configured to multiplex and de-multiplex data packet network transmission between the locations and use data compression, network-based and/or content-based techniques to increase data throughput between the locations. At step 222, one or more of a Filezilla FTP client, Firefox Web Browser client, or other client is configured to communicate data packets via the data tunnel. At step 224, a computer at the first location makes a request to access resources at the second location, which is communicated to the second location via the network proxy data tunnel.

The present invention may be conveniently implemented using one or more conventional general purpose or specialized digital computers or microprocessors programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for providing for providing a network proxy data tunnel, comprising:
one or more proxy servers, which provide a data tunnel between computers at a first location accessing resources at a second location;
wherein the data tunnel is configured to multiplex and de-multiplex data packet network transmission between the locations and use data compression, network-based and/or content-based techniques to increase data throughput between the locations.

2. The system of claim 1, wherein the resources at the second location are one or more of Web, file, streaming or other resources.

3. The system of claim 1, further comprising one or more of a Filezilla FTP client, Firefox Web Browser client, or other client configured to communicate data packets via the data tunnel.

4. The system of claim 1, wherein the proxy server is provided as an OS kernel driver model.

5. The system of claim 1, further comprising allowing the computer at the first location to access resources at an additional server.

6. The system of claim 1, further comprising deploying the data tunnel in a complex network architecture that includes multiple locations connected by a data tunnel network.

7. The system of claim 1, further comprising deploying the data tunnel in a cloud environment.

8. A method for providing for providing a network proxy data tunnel, comprising the steps of:
providing one or more proxy servers, which provide a data tunnel between computers at a first location accessing resources at a second location;
wherein the data tunnel is configured to multiplex and de-multiplex data packet network transmission between the locations and use data compression, network-based and/or content-based techniques to increase data throughput between the locations.

9. The method of claim 8, wherein the resources at the second location are one or more of Web, file, streaming or other resources.

10. The method of claim 8, further comprising providing one or more of a Filezilla FTP client, Firefox Web Browser client, or other client configured to communicate data packets via the data tunnel.

11. The method of claim 8, wherein the proxy server is provided as an OS kernel driver model.

12. The method of claim 8, further comprising allowing the computer at the first location to access resources at an additional server.

13. The method of claim 8, further comprising deploying the data tunnel in a complex network architecture that includes multiple locations connected by a data tunnel network.

14. The method of claim 8, further comprising deploying the data tunnel in a cloud environment.
